(19) United States
(12) Patent Application Publication
(10) Pub. No.: US 2008/0104810 A1
(43) Pub. Date: May 8, 2008

(54) Snap hook with slidable lock

(76) Inventor: Feng Chia Liang, Taichung (TW)

Correspondence Address: CHARLES E. BAXLEY, ESQ., 90 JOHN STREET, THIRD FLOOR, NEW YORK, NY, 10038, US

(21) Appl. No.: 11/594,345

(22) Filed: Nov. 7, 2006

(51) Int. Cl. F16B 45/02

(52) U.S. Cl. 24/600.2

(57) ABSTRACT

A snap hook includes a hook member having a gap formed by an attaching end and a receiving end, a pivotal gate pivotally secured to the attaching end of the hook member with an axle and having a latch pin attached to a latching end for selectively engaging with the hook member, and a locking member slidably engaged onto the pivotal gate and having one end movable to engage with the hook member and to lock the pivotal gate to the hook member. The locking member may be forced to engage with the hook member by a spring member in order to solidly lock the pivotal gate to the hook member at the locking position.

### BACKGROUND OF THE INVENTION

1. Field of the Invention

The present invention relates to a snap hook or S-hook or the like, and more particularly to a snap hook or S-hook including a slidable safety locking member slidably attached to a pivotal gate for solidly locking C-shaped hook body.

2. Description of the Prior Art

Typical coupling devices or snap hooks comprise an elongated body member pivotally attached to a handle or loop and including a hook formation formed or provided on one end for engaging with a cable or other objects, and a sleeve slidably attached onto the elongated body member and movable relative to the elongated body member for selectively locking the hook formation and thus for stably anchoring or locking or securing the cable or other objects to the elongated body member.

For example, U.S. Pat. No. 3,861,007 to Silverman discloses one of the typical swivel coupling devices comprising a central elongate body member with a hook formation formed or provided on one end and a swivel ring at the other end. A telescoping sleeve is slidably attached onto the elongated body member and movable relative to the elongated body member for selectively locking the hook formation to form a closed loop and thus for stably anchoring or locking or securing the cable or other objects to the elongated body member.

However, the size or dimension or opening of the hook formation is limited and may not be used to lock the larger objects or the like.

U.S. Pat. No. 5,608,953 to Petzl et al. discloses another typical snap hook comprising a pivoting finger associated to a locking ring movable in rotation between a first locking position and a second unlocking position, and a locking bolt cooperates with the ring to lock the ring positively in the first locking position. However, the locking ring is rotatable relative to the pivoting finger and may not be moved longitudinally relative to the pivoting finger and thus may not be moved to solidly engage with a C-shaped metallic body.

U.S. Pat. No. 5,791,025 to Maurice et al. discloses a further typical snap hook comprising a pivoting finger with a rotary locking ring cooperating with a locking bolt, and the locking bolt includes an operating component designed to cooperate alternately with a notch arranged in the locking ring and movable in rotation between a first locking position and a second unlocking position. However, similarly, the locking ring is rotatable relative to the pivoting finger and may not be moved longitudinally relative to the pivoting finger and thus may not be moved to solidly engage with a C-shaped metallic body.

The present invention has arisen to mitigate and/or obviate the afore-described disadvantages of the conventional snap hooks or S-hooks.

### SUMMARY OF THE INVENTION

The primary objective of the present invention is to provide a snap hook including a slidable safety locking member slidably attached to a pivotal gate and movable to engage with one end of a C-shaped hook body for solidly securing or locking the C-shaped hook body.

In accordance with one aspect of the invention, there is provided a snap hook comprising a hook member including a space formed therein, and including a gap formed therein and communicating with the space of the hook member for forming an attaching end and a receiving end, and including a latching notch formed in the receiving end of the hook member, a pivotal gate including a first end pivotally secured to the attaching end of the hook member with an axle for allowing the pivotal gate to be rotated relative to the hook member between a first locking position and a second unlocking position, the pivotal gate including a second end having a channel formed therein for selectively and slidably receiving the receiving end of the hook member, and a latch pin attached to the second end of the pivotal gate and engaged through the channel of the pivotal gate for selectively engaging with the latching notch of the hook member and for anchoring the pivotal gate to the hook member at the first locking position, a locking member including a bore formed therein for slidably receiving and engaging onto the pivotal gate and movable along the pivotal gate, and including a first end movable to engage with the hook member for selectively locking the pivotal gate to the hook member, and a spring biasing device for biasing the first end of the locking member to engage with the hook member and to selectively lock the pivotal gate to the hook member at the first locking position and for preventing the first end of the locking member from being disengaged from the hook member inadvertently. The first end of the locking member is movable and disengageable from the hook member when the locking member is moved relative to the hook member and the pivotal gate against the biasing device and for allowing one or more cables or other objects to be engaged into the space of the hook member.

The hook member includes an anchoring seat formed in the receiving end thereof for selectively engaging with the first end of the locking member.

The locking member includes an inner peripheral shoulder formed therein, and the biasing device includes a spring member engaged with the inner peripheral shoulder of the locking member for biasing and forcing the locking member to engage onto the receiving end of the hook member. The pivotal gate includes a peripheral shoulder formed therein for engaging with the spring member.

The axle includes a head extended out of the pivotal gate, and the locking member includes a second end having a locking groove formed therein for slidably receiving the head of the axle and for guiding the locking member to move relative to the hook member and the pivotal gate.

The locking groove of the locking member is an inclined locking groove for guiding the locking member to move longitudinally and radially relative to the hook member and the pivotal gate. The locking groove of the locking member includes an opening for slidably receiving the head of the axle and for allowing the head of the axle to be engaged into the inclined locking groove of the locking member.

The locking member includes a second end having a passage formed therein for slidably receiving the attaching end of the hook member and for allowing the locking member to be rotated relative to the hook member for a limited rotational angle. The pivotal gate includes a notch formed in the first end thereof for receiving the attaching end of the hook member.

The pivotal gate includes a positioning member engaged therein and engageable with the attaching end of the hook member for anchoring and positioning the pivotal gate to the hook member either at the first locking position or at the second unlocking position.

The pivotal gate includes a cavity formed in the first end thereof for receiving the positioning member. The pivotal gate includes a spring member engaged in the cavity thereof and engaged with the positioning member for biasing the positioning member to engage with the attaching end of the hook member and for anchoring and positioning the pivotal gate to the hook member either at the first locking position or at the second unlocking position.

The hook member includes at least one cut-off portion formed in the attaching end of the hook member for forming a rectangular cross section. The hook member includes at least one cut-off portion formed in the receiving end of the hook member for forming a rectangular cross section.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a snap hook in accordance with the present invention;

FIG. 2 is a partial exploded view of the snap hook;

FIG. 3 is an exploded view of the snap hook;

FIG. 4 is a perspective view illustrating slidable safety locking member of the snap hook;

FIG. 5 is a plan schematic view of the snap hook; and

FIG. 6 is a plan schematic view similar to FIG. 5, illustrating the operation of the snap hook.

### DETAILED DESCRIPTION OF THE PREFERRED EMBODIMENT

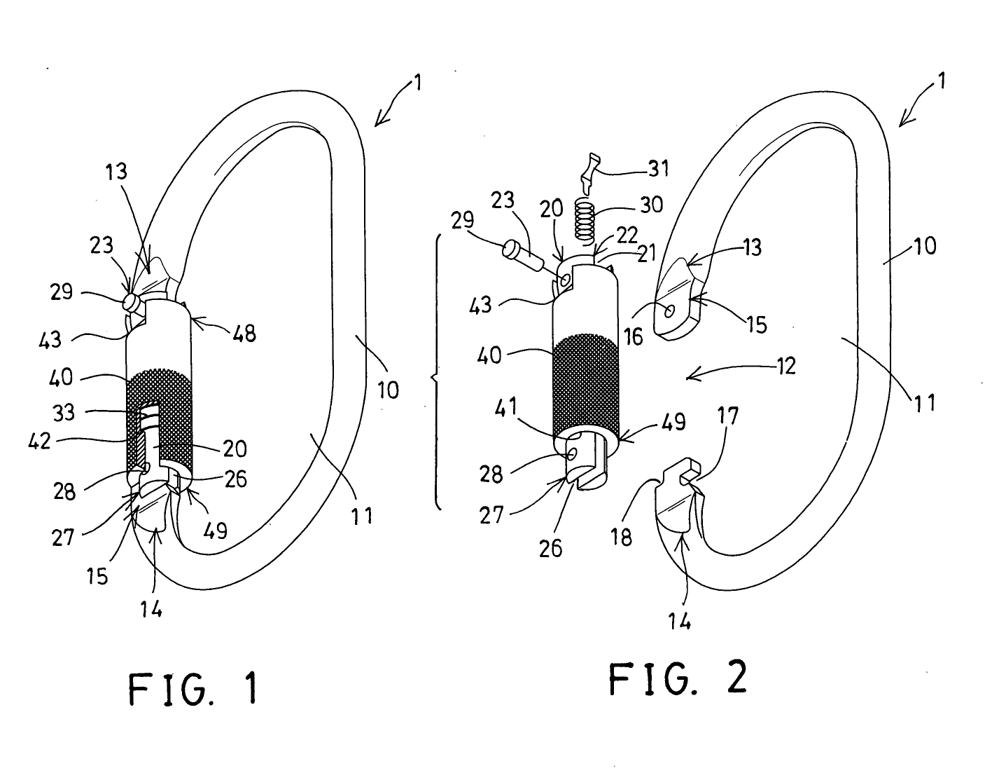

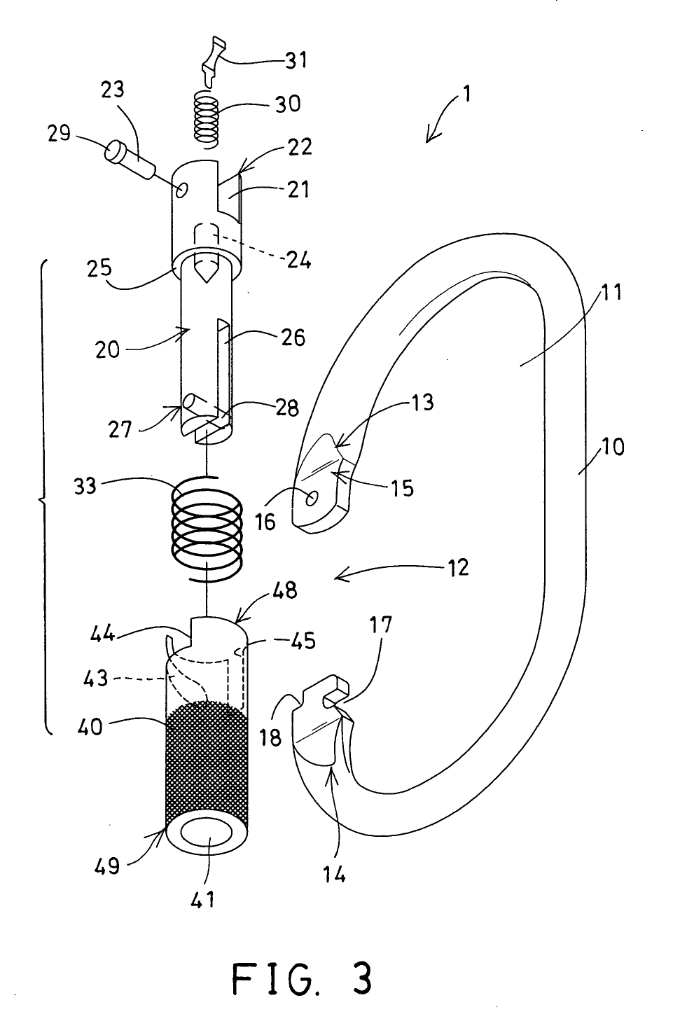

Referring to the drawings, and initially to FIGS. 1-3, a snap hook 1 in accordance with the present invention comprises a C-shaped hook body or member 10 including a space 11 formed therein for receiving one or more cables (not shown) or other objects, and including a gap 12 formed therein and communicating with the space 11 thereof for forming or defining two free ends 13, 14, such as a first or attaching end 13 and a second or receiving end 14. It is preferable that the C-shaped hook member 10 is bent or formed with an elongated rod which includes a circular cross section, and the hook member 10 includes one or more cut-off portions 15 formed in each of the free ends 13, 14 for forming a flat structure or a square or rectangular cross section for each of the free ends 13, 14.

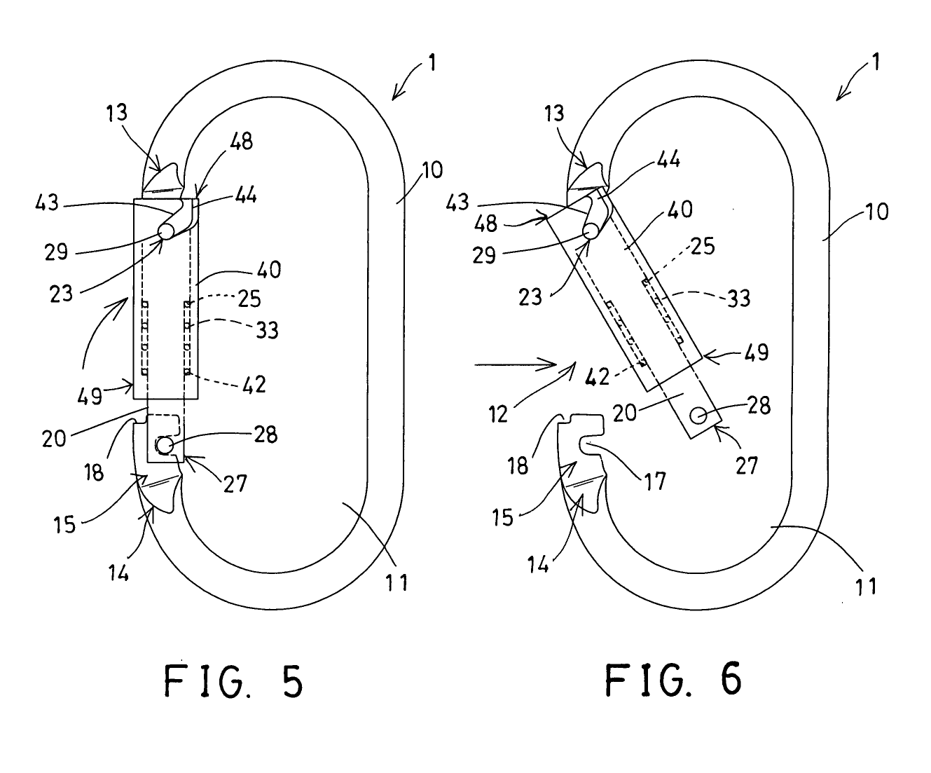

The hook member 10 further includes an orifice 16 formed in one end 13, such as formed in the attaching end 13 thereof, and an latching notch 17 formed in the other or receiving end 14, such as formed in the receiving end 14 thereof, and an anchoring recess or seat 18 also formed in the other end 14 or the receiving end 14 thereof. A pivotal shank or gate 20 includes a notch 21 formed in one or first end 22 thereof for receiving the attaching end 13 of the hook member 10, an axle 23 is attached to the first end 22 of the pivotal gate 20 and engaged through the notch 21 of the pivotal gate 20 and further engaged through the orifice 16 at the attaching end 13 of the hook member 10 for pivotally or rotatably attaching or securing the pivotal gate 20 to the hook member 10 and for allowing the pivotal gate 20 to be rotated relative to the hook member 10 between a first locking position (FIGS. 1, 5) and a second unlocking position (FIG. 6).

The pivotal gate 20 further includes a cavity 24 formed in the first end 22 thereof for receiving a spring member 30 and/or a spring blade or positioning member 31 which may be biased by the spring member 30 to engage with the attaching end 13 of the hook member 10 for anchoring or positioning the pivotal gate 20 to the hook member 10 either at the first locking position (FIGS. 1, 5) or at the second unlocking position (FIG. 6). One example of the operation or the engagement of the spring member 30 and/or the spring blade or positioning member 31 with the attaching end 13 of the hook member 10 is typical and has been disclosed in U.S. Pat. No. 5,608,953 to Petzl et al. which may then be taken as a reference for the present invention. It is preferable that the pivotal gate 20 further includes a peripheral shoulder 25 formed in the middle portion thereof for engaging with a spring biasing means or device or a spring member 33 which may be engaged onto the pivotal gate 20 and engaged with the peripheral shoulder 25 of the pivotal gate 20.

The pivotal gate 20 further includes a channel 26 formed in the other or second or latching end 27 thereof for selectively and slidably receiving the receiving end 14 of the hook member 10, and includes a latch pin 28 attached to the second end 27 of the pivotal gate 20 and engaged through the channel 26 of the pivotal gate 20 for selectively engaging with the latching notch 17 of the hook member 10 (FIG. 5) and for anchoring or latching the pivotal gate 20 to the hook member 10 at the first locking position (FIGS. 1, 5). The pivotal gate 20 may also be pivoted or rotated relative to the hook member 10 to the second unlocking position (FIG. 6) for selectively disengaging the latch pin 28 from the latching notch 17 of the hook member 10 and for allowing the cables or other objects to be engaged into the space 11 via the gap 12 of the hook member 10.

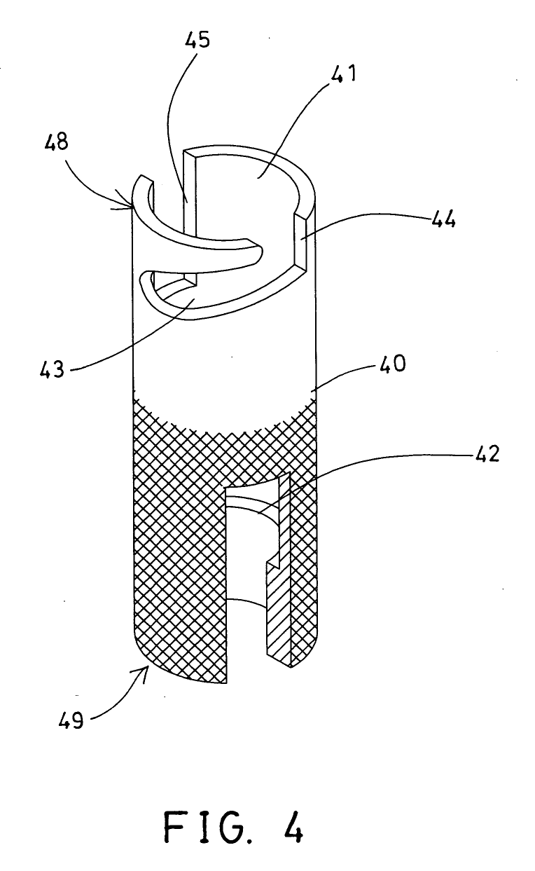

The snap hook 1 further includes a slidable sleeve or tubular or cylindrical safety locking member 40 having a bore 41 formed therein for slidably receiving or engaging onto the pivotal gate 20 and rotatable relative to the pivotal gate 20 and movable longitudinally along the pivotal gate 20, the safety locking member 40 includes an inner peripheral shoulder 42 formed therein (FIGS. 4-6) for engaging with the spring member 33 which may be engaged with the safety locking member 40 for forcing or biasing the safety locking member 40 to engage onto the receiving end 14 of the hook member 10 and for selectively or solidly latching or locking the pivotal gate 20 to the hook member 10 at the first locking position (FIG. 1) and thus for preventing the pivotal gate 20 from being moved away from the hook member 10 to the second unlocking position.

The safety locking member 40 includes one or first end 49 to be forced or biased to engage with the anchoring seat 18 of the hook member 10 which may limit the safety locking member 40 to move relative to the hook member 10 and which may anchor or position the safety locking member 40 to the hook member 10. The safety locking member 40 further includes an inclined or helical locking groove 43 formed in the other or second end 48 thereof and having an opening 44 for selectively and slidably receiving an enlarged head 29 of the axle 23 which is extended out of the pivotal gate 20 and which may guide the safety locking member 40 to move helically or to move both longitudinally and radially relative to the hook member 10 and the pivotal gate 20, and thus for guiding the one or first end 49 of the safety locking member 40 to selectively engage with the hook member 10 or to be disengaged from the hook member 10.

It is preferable that the safety locking member 40 further includes a passage 45 formed in the other or second end 48 thereof for selectively and slidably receiving the attaching end 13 of the hook member 10, and for allowing the safety locking member 40 to rotate relative to the hook member 10 for a limited rotational angle, and for allowing the one or first end 49 of the safety locking member 40 to be suitably or selectively disengaged from the hook member 10. It is to be noted that the one or first end 49 of the safety locking member 40 may also be forced or biased to engage with the anchoring seat 18 of the hook member 10 without the sliding engagement of the enlarged head 29 of the axle 23 with the inclined or helical groove 43 of the safety locking member 40. However, the sliding engagement of the enlarged head 29 of the axle 23 with the inclined or helical groove 43 of the safety locking member 40 may prevent the safety locking member 40 from being easily moved relative to the hook member 10 and the pivotal gate 20 against the spring member 33.

In operation, as shown in FIG. 6, the safety locking member 40 may be moved relative to the hook member 10 and the pivotal gate 20 against the spring member 33 and/or the enlarged head 29 of the axle 23 may be moved or caused to slide or to engage into the inclined or helical groove 43 of the safety locking member 40 for allowing the one or first end 49 of the safety locking member 40 to be disengaged from the hook member 10 and thus for allowing the safety locking member 40 and the pivotal gate 20 to be pivoted or rotated relative to the hook member 10 to the second unlocking position and thus for allowing the latch pin 28 of the pivotal gate 20 to be disengaged from the latching notch 17 of the hook member 10 or to be selectively engaged with the latching notch 17 of the hook member 10 (FIG. 5).

When it is required to latch or lock the pivotal gate 20 to the hook member 10, it is only required to release the safety locking member 40, and the spring member 33 may bias and force the one or first end 49 of the safety locking member 40 to engage with the hook member 10, particularly to engage with the anchoring seat 18 of the hook member 10 for solidly securing or locking the pivotal gate 20 to the hook member 10 and for preventing the pivotal gate 20 from being disengaged or moved away from the hook member 10 inadvertently.

Accordingly, the snap hook in accordance with the present invention includes a slidable safety locking member slidably attached to the pivotal gate and movable to engage with one end of the C-shaped hook body for solidly securing or locking the C-shaped hook body.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A snap hook comprising:
a hook member including a space formed therein, and including a gap formed therein and communicating with said space of said hook member for forming an attaching end and a receiving end, and including a latching notch formed in said receiving end of said hook member,
a pivotal gate including a first end pivotally secured to said attaching end of said hook member with an axle for allowing said pivotal gate to be rotated relative to said hook member between a first locking position and a second unlocking position, said pivotal gate including a second end having a channel formed therein for selectively and slidably receiving said receiving end of said hook member, and a latch pin attached to said second end of said pivotal gate and engaged through said channel of said pivotal gate for selectively engaging with said latching notch of said hook member and for anchoring said pivotal gate to said hook member at said first locking position,
a locking member including a bore formed therein for slidably receiving and engaging onto said pivotal gate and movable along said pivotal gate, and including a first end movable to engage with said hook member for selectively locking said pivotal gate to said hook member, and
means for biasing said first end of said locking member to engage with said hook member and to selectively lock said pivotal gate to said hook member at said first locking position, said first end of said locking member being movable and disengageable from said hook member when said locking member is moved relative to said hook member and said pivotal gate against said biasing means.

2. The snap hook as claimed in claim 1, wherein said hook member includes an anchoring seat formed in said receiving end thereof for selectively engaging with said first end of said locking member.

3. The snap hook as claimed in claim 1, wherein said locking member includes an inner peripheral shoulder formed therein, and said biasing means includes a spring member engaged with said inner peripheral shoulder of said locking member for biasing and forcing said locking member to engage onto said receiving end of said hook member.

4. The snap hook as claimed in claim 3, wherein said pivotal gate includes a peripheral shoulder formed therein for engaging with said spring member.

5. The snap hook as claimed in claim 1, wherein said axle includes a head extended out of said pivotal gate, and said locking member includes a second end having a locking groove formed therein for slidably receiving said head of said axle and for guiding said locking member to move relative to said hook member and said pivotal gate.

6. The snap hook as claimed in claim 5, wherein said locking groove of said locking member is an inclined locking groove for guiding said locking member to move longitudinally and radially relative to said hook member and said pivotal gate.

7. The snap hook as claimed in claim 5, wherein said locking groove of said locking member includes an opening for slidably receiving said head of said axle.

8. The snap hook as claimed in claim 1, wherein said locking member includes a second end having a passage formed therein for slidably receiving said attaching end of said hook member.

9. The snap hook as claimed in claim 1, wherein said pivotal gate includes a notch formed in said first end thereof for receiving said attaching end of said hook member.

10. The snap hook as claimed in claim 1, wherein said pivotal gate includes a positioning member engaged therein and engageable with said attaching end of said hook member for anchoring and positioning said pivotal gate to said hook member either at said first locking position or at said second unlocking position.

11. The snap hook as claimed in claim 10, wherein said pivotal gate includes a cavity formed in said first end thereof for receiving said positioning member.

12. The snap hook as claimed in claim 11, wherein said pivotal gate includes a spring member engaged in said cavity thereof and engaged with said positioning member for biasing said positioning member to engage with said attaching end of said hook member.

13. The snap hook as claimed in claim 1, wherein said hook member includes at least one cut-off portion formed in said attaching end of said hook member for forming a rectangular cross section.

14. The snap hook as claimed in claim 1, wherein said hook member includes at least one cut-off portion formed in said receiving end of said hook member for forming a rectangular cross section.
